(19) United States
(12) Patent Application Publication
(10) Pub. No.: US 2024/0158933 A1
(43) Pub. Date: May 16, 2024

(54) CATALYST FOR AN ELECTROCHEMICAL REACTION CAPABLE OF SELECTIVE OXIDATION OR REDUCTION OF AN ACTIVE MATERIAL AND A METHOD OF PREPARING SAME

(71) Applicants: HYUNDAI MOTOR COMPANY, Seoul (KR); KIA CORPORATION, Seoul (KR)

(72) Inventor: Hee Su Yang, Yongin-si (KR)

(73) Assignees: HYUNDAI MOTOR COMPANY, Seoul (KR); KIA CORPORATION, Seoul (KR)

(21) Appl. No.: 18/226,654

(22) Filed: Jul. 26, 2023

(30) Foreign Application Priority Data
Nov. 15, 2022 (KR) 10-2022-0152165

(51) Int. Cl. C25B 11/04

(52) U.S. Cl. CPC C25B 11/04

(57) ABSTRACT

A catalyst for electrochemical reaction and a method of preparing the same are disclosed. Particularly, a heat treatment method is disclosed for oxidizing or reducing only a specific active material in a synthesized catalyst in which two or more active materials are mixed.

### CROSS-REFERENCE TO RELATED APPLICATION

This application claims, under 35 U.S.C. § 119(a), the benefit of priority from Korean Patent Application No. 10-2022-0152165, filed on Nov. 15, 2022, the entire contents of which are incorporated herein by reference.

### BACKGROUND

### (a) Technical Field

The present disclosure relates to a catalyst for an electrochemical reaction and a method of preparing the same.

### (b) Background Art

When a metal precursor is mixed with a nitrate-based material such as sodium nitrate or the like and heat-treated at 300° C. or higher, a metal oxide is synthesized. As such, the method of synthesizing the catalyst in the above manner is exemplified by the Adams fusion synthesis method. This synthesis method facilitates mass production and is mainly performed using a single metal that has a large particle size and is active in a specific reaction. Here, if reaction conditions such as a heat treatment temperature and the like are properly adjusted, even when two or more metal precursors are used, it is possible to synthesize bimetallic or multi-metallic catalysts in which small grains of each metal are densely aggregated to form grain boundaries.

Recently, it has been reported that stability is improved when other types of zero-valent metals are mixed with metal oxides that have good activity in electrochemical reactions. However, colloidal synthesis, which is used for such complicated synthesis, has problems in that the reaction time is long, the process is complicated, and mass synthesis is difficult.

### SUMMARY

The present disclosure has been made keeping in mind the problems encountered in the related art. An object of the present disclosure is to provide a heat treatment method for oxidizing or reducing only a specific active material in a synthesized catalyst in which two or more active materials are mixed.

The objects of the present disclosure are not limited to the foregoing. The objects of the present disclosure should be more clearly understood through the following description and may be realized by the means described in the claims and combinations thereof.

An embodiment of the present disclosure provides a method of preparing a catalyst for an electrochemical reaction. The method includes step (1) of synthesizing a catalyst including a first active material and a second active material having a higher oxidation temperature than an oxidation temperature of the first active material. The method also includes step (2) of imparting fluidity to the catalyst by heat-treating the catalyst and reducing the first active material and the second active material. The method further includes step (3) of maintaining fluidity of the catalyst and step (4) of selectively oxidizing the first active material by performing heat treatment at a temperature lower than the oxidation temperature of the second active material.

Each of the first active material and the second active material in step (1) may include at least one selected from the group consisting of, or may comprise: metalloids including boron (B), silicon (Si), germanium (Ge), arsenic (As), antimony (Sb), tellurium (Te), or polonium (Po); alkali metals including lithium (Li), sodium (Na), potassium (K), rubidium (Rb), cesium (Cs), or francium (Fr); alkaline earth metals including beryllium (Be), magnesium (Mg), calcium (Ca), strontium (Sr), barium (Ba), or radium (Ra); transition metals including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs), meitnerium (Mt), darmstadtium (Ds), roentgenium (Rg), or copernicium (Cn); or oxides thereof; or any combination thereof.

In step (1), the first active material may be ruthenium oxide (RuO₂) and the second active material may be platinum oxide (PtO₂).

The catalyst of step (1) may include the first active material and the second active material in a mass ratio in a range of 0.1 to 10:1.

Step (2) may be performed within a range of 30 minutes to 3 hours at a temperature in a range of 350° C. to 550° C. in a hydrogen atmosphere.

Step (3) may be performed at a temperature in a range of 200° C. to 500° C. and may include purging with an inert gas or purging with a gas that creates an oxidizing atmosphere.

The inert gas may include at least one selected from the group consisting of, or may comprise, nitrogen (N₂), helium (He), neon (Ne), argon (Ar), krypton (Kr), xenon (Xe), radon (Rn), or any combination thereof. The gas that creates the oxidizing atmosphere may be a gas mixture containing 5% or more of oxygen (O₂).

Step (4) may be performed within a range of 1 hour to 3 hours at a temperature in a range of 300° C. to 500° C. in a gas atmosphere containing 5% or more of oxygen (O₂).

The peaks of the catalyst may be observed at 2θ=28°±1°, 35°±1°, 40°±1°, 46°±1°, 54°±1°, 68°±1°, and 81°±1° in an XRD spectrum.

Another embodiment of the present disclosure provides a method of preparing a catalyst for an electrochemical reaction. The method includes step (1) of synthesizing a catalyst including a first active material and a second active material having a higher reduction temperature than a reduction temperature of the first active material. The method also includes step (2) of imparting fluidity to the catalyst by heat-treating the catalyst and oxidizing the first active material and the second active material. The method further includes step (3) of maintaining fluidity of the catalyst and step (4) of selectively reducing the first active material by performing heat treatment at a temperature lower than the reduction temperature of the second active material.

Each of the first active material and the second active material in step (1) may include at least one selected from the group consisting of, or may comprise: metalloids including boron (B), silicon (Si), germanium (Ge), arsenic (As), antimony (Sb), tellurium (Te), or polonium (Po); alkali metals including lithium (Li), sodium (Na), potassium (K), rubidium (Rb), cesium (Cs), or francium (Fr); alkaline earth metals including beryllium (Be), magnesium (Mg), calcium (Ca), strontium (Sr), barium (Ba), or radium (Ra); transition metals including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs), meitnerium (Mt), darmstadtium (Ds), roentgenium (Rg), or copernicium (Cn); or oxides thereof; or any combination thereof.

In step (1), the first active material may be ruthenium (Ru) and the second active material may be platinum (Pt). The catalyst may include the first active material and the second active material in a mass ratio in a range of 0.1 to 10:1.

Step (2) may be performed within a range of 1 hour to 3 hours at a temperature in a range of 300° C. to 500° C. in a gas atmosphere containing 5% or more of oxygen (O₂).

Step (3) may be performed at a temperature in a range of 200° C. to 500° C. and may include purging with an inert gas or purging with a gas that creates a reducing atmosphere.

Step (4) may be performed within a range of 30 minutes to 3 hours at a temperature in a range of 350° C. to 550° C. in a hydrogen atmosphere.

The peaks of the catalyst may be observed at 2θ=28°±1°, 35°±1°, 40°±1°, 46°±1°, 54°±1°, 68°±1°, and 81°±1° in an XRD spectrum.

Another embodiment of the present disclosure provides a catalyst for an electrochemical reaction. The catalyst includes a first active material and a second active material having an oxidation temperature, a reduction temperature, or both higher than that of the first active material. Oxidation states of the first active material and the second active material may be different from each other.

The first active material may include ruthenium oxide (RuO₂) and the second active material may include platinum (Pt).

The peaks of the catalyst may be observed at 2θ=28°±1°, 35°±1°, 40°±1°, 46°±1°, 54°±1°, 68°±1°, and 81°±1° in an XRD spectrum.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 schematically shows a process of preparing a catalyst according to an embodiment of the present disclosure;

FIG. 2 is a flowchart showing the process of preparing a catalyst according to an embodiment of the present disclosure;

FIG. 3 shows Transmission Electron Microscope (TEM) images of a catalyst synthesized through a conventional catalyst synthesis process;

FIG. 4 is a flowchart showing a process of preparing a catalyst according to another embodiment of the present disclosure;

FIG. 5 shows results of X-Ray Diffraction (XRD) of the catalyst synthesized in step (1) of the preparation process according to an embodiment of the present disclosure;

FIG. 6 shows results of Transmission Electron Microscope (TEM) Energy Dispersive Spectrometer (EDS) analysis of the catalyst synthesized in step (1) of the preparation process according to an embodiment of the present disclosure;

FIG. 7 shows results of X-Ray Diffraction (XRD) of Example 1 prepared through the preparation process according to an embodiment of the present disclosure;

FIG. 8 shows results of X-Ray Diffraction (XRD) of Comparative Example 1;

FIG. 9 shows results of X-Ray Diffraction (XRD) of Comparative Example 2;

FIG. 10 shows results of X-Ray Diffraction (XRD) of Comparative Example 3;

FIG. 11 shows results of X-Ray Diffraction (XRD) of Comparative Example 4; and

FIG. 12 shows results of X-Ray Diffraction (XRD) of Comparative Example 5.

### DETAILED DESCRIPTION

The above and other objects, features, and advantages of the present disclosure should be more clearly understood from the following embodiments taken in conjunction with the accompanying drawings. However, the present disclosure is not limited to the embodiments disclosed herein and the disclosed embodiments may be modified into different forms. These embodiments are provided to thoroughly explain the disclosure and to sufficiently transfer the spirit of the present disclosure to those of ordinary skill in the art.

Throughout the drawings, the same reference numerals will refer to the same or like elements. For the sake of clarity of the present disclosure, the dimensions of structures are depicted as being larger than the actual sizes thereof. It should be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, etc., and variations thereof, when used in this specification, specify the presence of stated features, integers, steps, operations, elements, components, or combinations thereof. Such terms do not preclude the presence or addition of one or more other features, integers, steps, operations, elements, components, or combinations thereof. Also, it should be understood that, when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. Further, with respect to such ranges, it should be understood that the above-mentioned modifier “about” and the measurement uncertainties and approximations are equally applicable.

The present disclosure pertains to a method of preparing a catalyst for an electrochemical reaction capable of selective oxidation or reduction of an active material.

In general, when metals having different oxidation temperatures or reduction temperatures, for example, metal A having an oxidation temperature of 100° C. and metal B having an oxidation temperature of 200° C., form a heterogeneous interface, during heat treatment under oxygen or air conditions at a temperature ranging from 100 to 200° C., only metal A that meets thermodynamic oxidation conditions is oxidized. Thus, the oxidation number of metal A alone is increased, whereas the zero-valent oxidation number of most metal B is maintained. The same tendency is observed even when heat treatment is performed under hydrogen gas conditions.

Oxidizing or reducing only one metal of a bimetallic or multi-metallic catalyst based on the above thermodynamic principle is typically regarded as a high-level method. In addition, laboratories and industries that study catalyst synthesis use more complicated synthesis methods such as the polyol method or colloidal synthesis, rather than metal oxide synthesis, which is an old synthesis method that is not easy to tune. The purpose of the present disclosure is not common. The purpose intends to apply a complicated method of changing only the oxidation number of a portion of metals to a catalyst prepared by a metal oxide synthesis method that is a simple synthesis method.

Although the present disclosure is differentiated in view of purpose, the realization method thereof is also not simple. This is because bimetallic or multi-metallic catalysts synthesized by the metal oxide synthesis method are characterized in that all metals are simultaneously oxidized or reduced, rather than oxidizing or reducing only a metal having a lower oxidation temperature, due to numerous grain boundaries. In this patent, by maintaining the fluidity of the metal through a special heat treatment method, grains are allowed to operate independently to synthesize a catalyst having different oxidation states. Ultimately, the present disclosure aims to improve stability by introducing a zero-valent metal while maintaining the activity of a metal oxide that shows good catalytic activity in an electrochemical reaction. In addition, the present disclosure is applicable to all cases in which only the oxidation state of a specific metal is desired to be changed even if it is not initially synthesized as a metal oxide.

The present disclosure aims to provide a catalyst showing good activity and durability using a bimetallic or multi-metallic catalyst having a specific oxidation number in an electrode for electrochemical reaction. A specific active material is oxidized to maintain good activity of the metal oxide, while the other active material has a zero-valent state. Thus, electrons are provided from the metal oxide to prevent dissolution due to peroxidation of the metal oxide, ultimately improving performance of the catalyst.

Hereinafter, embodiments and the technical concepts of the present disclosure are described in more detail with reference to the accompanying drawings.

### Method of Preparing Catalyst for Electrochemical Reaction

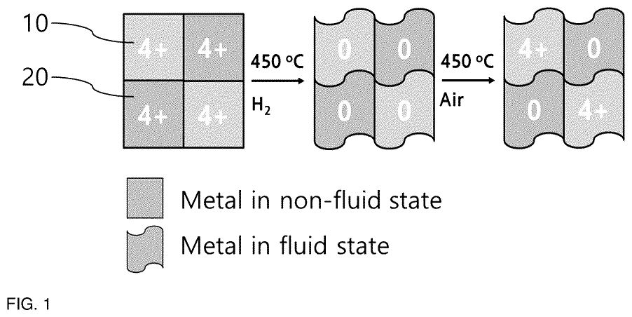

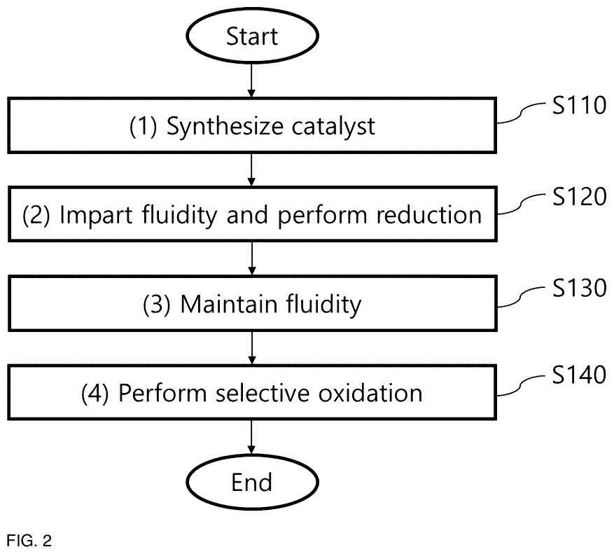

FIG. 1 schematically shows a process of preparing a catalyst according to an embodiment of the present disclosure. FIG. 2 is a flowchart showing the process of preparing a catalyst according to an embodiment of the present disclosure.

With reference thereto, the method of preparing a catalyst for an electrochemical reaction according to an embodiment of the present disclosure may include step (1) of synthesizing a catalyst including a first active material and a second active material having a higher oxidation temperature than that of the first active material (step S110). The method also includes step (2) of imparting fluidity to the catalyst by heat-treating the catalyst and reducing the first active material and the second active material (step S120). The method further includes step (3) of maintaining fluidity of the catalyst (step S130) and step (4) of selectively oxidizing the first active material by performing heat treatment at a temperature lower than the oxidation temperature of the second active material (step S140).

First, in step S110, a catalyst including a first active material and a second active material having a higher oxidation temperature than that of the first active material may be synthesized.

As used herein, the term “oxidation temperature” may refer to a temperature at which oxidation may occur. In the present disclosure, a catalyst composed of two or more metals is prepared using a metal oxide synthesis method, followed by continuous heat treatment under different gas conditions. Therefore, the first active material and the second active material are not limited, so long as they have different oxidation temperatures and selective oxidation is possible at a temperature therebetween.

The type of the first active material is not limited, but the first active material may include at least one selected from the group consisting of, or may comprise: metalloids such as boron (B), silicon (Si), germanium (Ge), arsenic (As), antimony (Sb), tellurium (Te), or polonium (Po); alkali metals such as lithium (Li), sodium (Na), potassium (K), rubidium (Rb), cesium (Cs), or francium (Fr); alkaline earth metals such as beryllium (Be), magnesium (Mg), calcium (Ca), strontium (Sr), barium (Ba), or radium (Ra); transition metals such as scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs), meitnerium (Mt), darmstadtium (Ds), roentgenium (Rg), or copernicium (Cn); or oxides thereof; or any combination thereof.

The type of the second active material is also not limited, but the second active material may include at least one selected from the group consisting of, or may comprise: metalloids such as boron (B), silicon (Si), germanium (Ge), arsenic (As), antimony (Sb), tellurium (Te), or polonium (Po); alkali metals such as lithium (Li), sodium (Na), potassium (K), rubidium (Rb), cesium (Cs), or francium (Fr); alkaline earth metals such as beryllium (Be), magnesium (Mg), calcium (Ca), strontium (Sr), barium (Ba), or radium (Ra); transition metals such as scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs), meitnerium (Mt), darmstadtium (Ds), roentgenium (Rg), or copernicium (Cn); or oxides thereof; or any combination thereof.

In an embodiment, the first active material is ruthenium oxide (RuO₂) and the second active material is platinum oxide (PtO₂).

In the Adams fusion synthesis method, which is a conventional method that facilitates mass synthesis, a catalyst composed of RuO₂ and PtO₂ is synthesized by simultaneously adding a ruthenium precursor (Ru Precursor) and a platinum precursor (Pt Precursor). Conventionally, when heat treatment is conducted in an H₂ environment, respective metals are reduced into platinum (Pt) and ruthenium (Ru). When the catalyst once reduced in this way is heat-treated under air conditions, respective metals are simultaneously oxidized into platinum oxide (PtO₂) and ruthenium oxide (RuO₂) or are not oxidized even if the temperature is increased and the time is increased.

In the present disclosure, however, a catalyst is provided having improved durability in which platinum (Pt) is bonded to ruthenium oxide (RuO₂) showing good activity in a water decomposition reaction. Heat treatment is performed at an appropriate temperature under different gas conditions while maintaining the fluidity of the catalyst particles.

The catalyst in step S110 may include the first active material and the second active material in a mass ratio in a range of 0.1 to 10:1. In an embodiment, the first and second active materials may be in a mass ratio in a range of 0.1 to 2:1.

Next, in step S120, the catalyst may be heat-treated to thus impart fluidity thereto and reduce the first active material and the second active material.

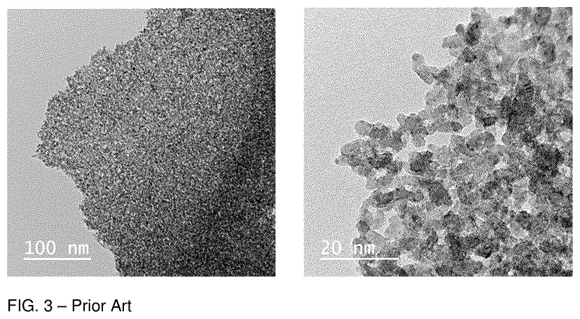

FIG. 3 shows Transmission Electron Microscope (TEM) images of a catalyst synthesized through a conventional catalyst synthesis method. With reference to FIG. 3, the catalyst of FIG. 3 is in a non-fluid state, and a solvent is not used, forming a grain boundary that is not physically easily broken by aggregating grains formed in each part of the reaction vessel. Forming a grain boundary means that it is almost impossible to separate grains one by one and also that there is a high tendency to behave in conjunction with surrounding elements, unlike catalysts in which particles are separated from each other and behave separately. Therefore, in order to selectively oxidize or reduce only a specific active material, the catalyst is heat-treated to thus impart fluidity thereto, and the reaction then proceeds while maintaining the fluidity thereof.

Step S120 may be performed in a hydrogen atmosphere.

Step S120 may be performed at a temperature in a range of 350° C. to 550° C. If the temperature is lower than 350° C., neither of the first active material and the second active material may be oxidized/reduced. On the other hand, if the temperature exceeds 550° C., heat treatment at an excessively high temperature may result in excessive deformation from the original state.

Step S120 may be performed for a time period in a range of 30 minutes to 3 hours. If the time exceeds 3 hours, oxidation/reduction may occur, but selective oxidation/reduction may be impossible.

Next, in step S130, fluidity of the catalyst may be maintained.

In the present disclosure, selective oxidation or reduction of a specific active material may be possible by allowing the next reaction to proceed in the presence of the catalyst, the fluidity of which is maintained.

Step S130 may be performed at a temperature in a range of 200° C. to 500° C. If this temperature is not maintained and heat treatment is not performed continuously, selective oxidation or reduction may be impossible.

Step S130 may include purging with an inert gas or purging with a gas that creates an oxidizing atmosphere.

The inert gas may include at least one selected from the group consisting of, or may comprise, nitrogen (N₂), helium (He), neon (Ne), argon (Ar), krypton (Kr), xenon (Xe), radon (Rn), or any combination thereof.

The gas that creates the oxidizing atmosphere may be a gas mixture containing 5% or more of oxygen (O₂).

Finally, in step S140, the first active material may be selectively oxidized by performing heat treatment at a temperature lower than the oxidation temperature of the second active material.

Step S140 may be performed in a gas atmosphere containing 5% or more of oxygen (O₂).

Step S140 may be performed at a temperature of about 350° C. to 550° C. If the temperature is lower than 350° C., neither of the first active material and the second active material may be oxidized/reduced. On the other hand, if the temperature exceeds 550° C., heat treatment at an excessively high temperature may result in excessive deformation from the original state.

Step S140 may be performed for a period of time in a range of 1 hour to 3 hours. If the time is less than 1 hour, selective oxidation/reduction may be impossible. On the other hand, if the time exceeds 3 hours, oxidation/reduction may occur, but selective oxidation/reduction may be impossible.

The peaks of the catalyst may be observed at 2θ=28°±1°, 35°±1°, 40°±1°, 46°±1°, 54°±1°, 68°±1°, and 81°±1° in an X-ray diffraction (XRD) spectrum. The diffraction angle, 2θ, is generally defined between the incident beam and the detector.

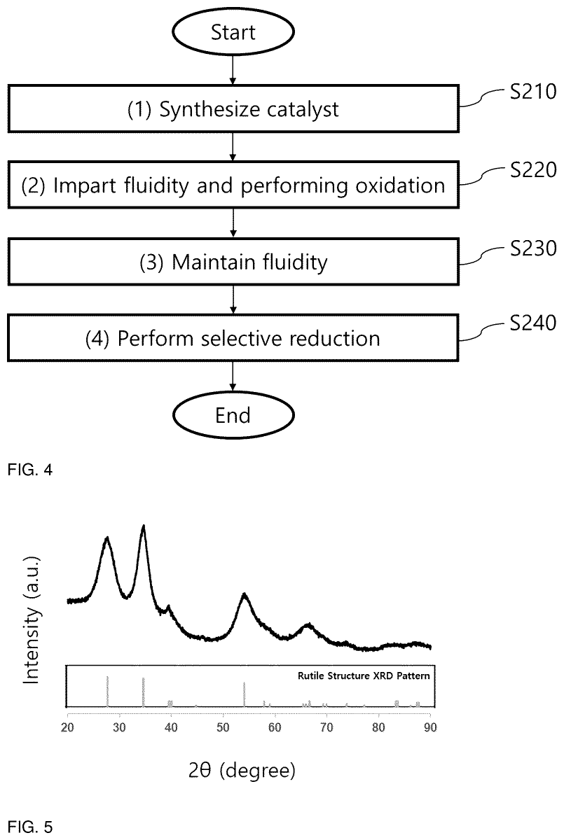

FIG. 4 is a flowchart showing a process of preparing a catalyst according to another embodiment of the present disclosure.

With reference thereto, the method of preparing a catalyst for electrochemical reaction according to another embodiment of the present disclosure may include step (1) of synthesizing a catalyst including a first active material and a second active material having a higher reduction temperature than that of the first active material (step S210). The method also includes step (2) of imparting fluidity to the catalyst by heat-treating the catalyst and oxidizing the first active material and the second active material (step S220). The method further includes step (3) of maintaining fluidity of the catalyst (step S230) and step (4) of selectively reducing the first active material by performing heat treatment at a temperature lower than the reduction temperature of the second active material (step S240).

First, in step S210, a catalyst including a first active material and a second active material having a higher reduction temperature than the first active material may be synthesized.

As used herein, the term “reduction temperature” may refer to a temperature at which reduction may occur. In the present disclosure, a catalyst composed of two or more metals is prepared using a metal oxide synthesis method, followed by continuous heat treatment under different gas conditions. Therefore, the first active material and the second active material are not limited, so long as they have different reduction temperatures and selective reduction is possible at a temperature therebetween.

Since the types and mass ratios of the first active material and the second active material are the same as those in step S110 described above, a redundant description thereof has been omitted.

The first active material may be ruthenium (Ru) and the second active material may be platinum (Pt).

Next, in step S220, the catalyst may be heat-treated to thus impart fluidity thereto and oxidize the first active material and the second active material.

With reference to FIG. 3, the catalyst of FIG. 3 is in a non-fluid state, and a solvent is not used, forming a grain boundary that is not physically easily broken by aggregating grains formed in each part of the reaction vessel. Forming a grain boundary means that it is almost impossible to separate grains one by one and also that there is a high tendency to behave in conjunction with surrounding elements, unlike catalysts in which particles are separated from each other and behave separately. Therefore, in order to selectively oxidize or reduce only a specific active material, the catalyst is heat-treated to thus impart fluidity thereto, and the reaction must proceed while maintaining the fluidity thereof.

Step S220 may be performed in a gas atmosphere containing 5% or more of oxygen (O₂).

Step S220 may be performed at a temperature in a range of 300° C. to 500° C. If the temperature is lower than 300° C., oxidation/reduction may occur only in some cases, and selective oxidation/reduction of a specific active material may be impossible. On the other hand, if the temperature is higher than 500° C., heat treatment at an excessively high temperature may result in excessive deformation from the original state.

Step S220 may be performed for a time period in a range of 1 hour to 3 hours. If the time is less than 1 hour, selective oxidation/reduction may be impossible. On the other hand, if the time exceeds 3 hours, oxidation/reduction may occur, but selective oxidation/reduction may be impossible.

Next, in step S230, fluidity of the catalyst may be maintained.

In the present disclosure, selective oxidation or reduction of a specific active material may be possible by allowing the next reaction to proceed in the presence of the catalyst, the fluidity of which is maintained.

Step S230 may be performed at a temperature in a range of 200° C. to 500° C. If this temperature is not maintained and heat treatment is not performed continuously, selective oxidation or reduction may be impossible.

Step S230 may include purging with an inert gas or purging with a gas that creates a reducing atmosphere.

The inert gas may include at least one selected from the group consisting of, or may comprise, nitrogen (N₂), helium (He), neon (Ne), argon (Ar), krypton (Kr), xenon (Xe), radon (Rn), or any combination thereof.

The gas that creates the reducing atmosphere may be a gas mixture containing hydrogen gas.

Finally, in step S240, the first active material may be selectively reduced by performing heat treatment at a temperature lower than the reduction temperature of the second active material.

Step S240 may be performed in a hydrogen atmosphere.

Step S240 may be performed at a temperature in a range of 350° C. to 550° C. If the temperature is lower than 350° C., neither of the first active material and the second active material may be reduced. On the other hand, if the temperature exceeds 550° C., heat treatment at an excessively high temperature may result in excessive deformation from the original state.

Step S240 may be performed for a time period in a range of 30 minutes to 3 hours. If the time exceeds 3 hours, oxidation/reduction may occur, but selective oxidation/reduction may be impossible.

The peaks of the catalyst may be observed at 2θ=28°±1°, 35°±1°, 40°±1°, 46°±1°, 54°±1°, 68°±1°, and 81°±1° in an X-ray diffraction (XRD) spectrum.

### Catalyst for Electrochemical Reaction

A catalyst for electrochemical reaction according to the present disclosure includes a first active material and a second active material. The second active material has an oxidation temperature, a reduction temperature, or both, higher than that of the first active material. The first active material and the second active material may have different oxidation states.

Since the first active material and the second active material are the same as those described above, a redundant description thereof has been omitted.

The oxidation states of the first active material and the second active material may be different from each other.

In the present disclosure, active materials having different oxidation states are included, thus maintaining the activity of a metal oxide showing good catalytic activity in an electrochemical reaction and improving stability by introducing a zero-valent metal.

The first active material may include ruthenium oxide (RuO₂) and the second active material may include platinum (Pt).

The peaks of the catalyst may be observed at 2θ=28°±1°, 35°±1°, 40°±1°, 46°±1°, 54°±1°, 68°±1°, and 81°±1° in an X-ray diffraction (XRD) spectrum. Specifically, peaks appearing at 2θ=40°±1°, 46°±1°, 68°±1°, and 81°±1° in the XRD (X-ray diffraction) spectrum may be attributed to platinum (Pt) included in the catalyst.

Also, peaks appearing at 2θ=28°±1°, 35°±1°, 40°±1°, 46°±1° and 54°±1° in the XRD (X-ray diffraction) spectrum may be attributed to ruthenium oxide (RuO₂).

Based on such results, it can be confirmed that the catalyst has a rutile structure and includes platinum (Pt) and ruthenium oxide (RuO₂).

A better understanding of the present disclosure may be obtained through the following examples and comparative examples. However, these examples are not to be construed as limiting the spirit of the present disclosure.

### Test Example 1: Result of Catalyst Synthesis in Step (1)

First, a catalyst including PtO₂ and RuO₂ was synthesized in step (1) (step S110) of a method of preparing a catalyst according to an embodiment of the present disclosure.

In step (1), 0.3 g of each of H₂PtCl₆ (hexachloroplatinic acid) and RuCl₃·xH₂O in a mass ratio of 1:1 purchased from Sigma Aldrich was added to a solvent mixture of IPA and EtOH and dissolved with stirring for 20 minutes. Subsequently, sodium nitrate purchased from Samchun was added thereto and the solvent was evaporated through stirring and heat treatment. Subsequently, the mixture in a powder form from which the solvent was evaporated was heat-treated in a furnace. Materials other than the catalyst were dissolved and removed using distilled water, thereby finally synthesizing a catalyst including PtO₂ and RuO₂ (step S110).

The catalyst thus synthesized was analyzed through TEM and XRD. The results thereof are shown in FIGS. 4 and 5.

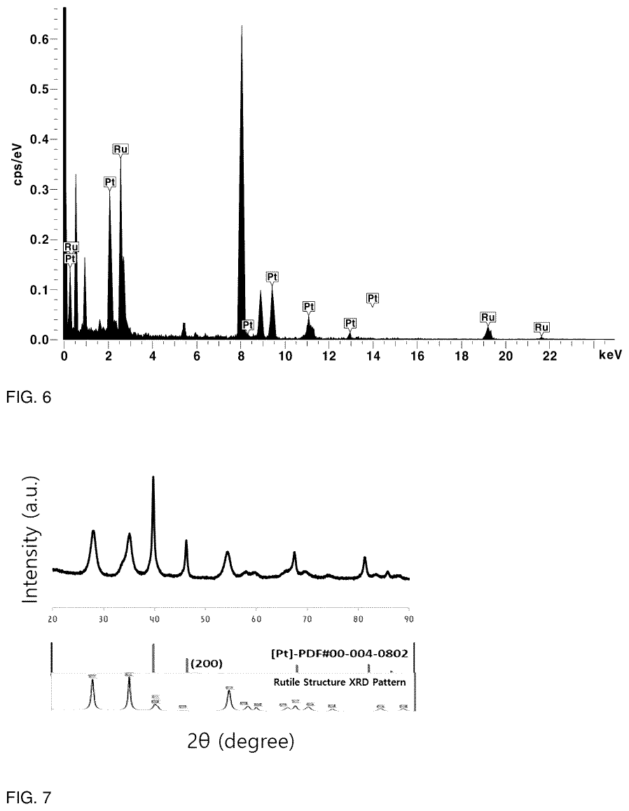

FIG. 5 shows results of XRD of the catalyst synthesized in step (1) of the preparation process according to an embodiment of the present disclosure. FIG. 6 shows results of TEM Energy Dispersive Spectrometer (EDS) analysis of the catalyst synthesized in step (1) of the preparation process according to an embodiment of the present disclosure. With reference thereto, it is possible to know what kind of crystal structure a crystalline material has. When the oxidation state changes, the crystal structure of the material also changes, and each material has a specific phase in each oxidation state, making it possible to determine whether it has been oxidized and which material has been oxidized.

For Ru, Ru(0) generally has an hcp phase and RuO₂ has a rutile phase. For Pt, Pt(0) has an fcc phase and PtO₂ has a rutile phase. As shown in FIG. 4, it was confirmed that the catalyst synthesized in the present disclosure had a rutile structure.

Using TEM EDS analysis, the mass ratio or elemental ratio of elements can be determined. As shown in FIG. 5, it was confirmed that Pt and Ru were present in a mass ratio of about 1:1.

Consequently, synthesis of PtO₂—RuO₂ in which Pt and Ru were present in a mass ratio of 1:1 in step (1) was confirmed.

### Test Example 2: Result of Analysis of Physical Properties of Catalyst as Final Material

### Example 1

The catalyst including PtO₂ and RuO₂ synthesized in step (1) was additionally subjected to steps (2), (3), and (4) of the preparation method of an embodiment of the present disclosure to obtain a catalyst including Pt and RuO₂.

In step (2), the catalyst synthesized in Test Example 1 was placed in an alumina boat, which was then placed in a furnace, and a reaction vessel was connected thereto. After purging with hydrogen gas at 300 sccm for 30 minutes to create a sufficient hydrogen atmosphere inside the reaction vessel, the internal temperature of the reaction vessel was raised to 450° C., followed by heat treatment for 2 hours immediately after reaching the target temperature (step S120).

In step (3), hydrogen gas was sufficiently discharged from the vessel through purging with argon (Ar) gas at 700 sccm for 15 minutes without lowering the temperature, and continuously, the inside of the reaction vessel was converted into a sufficient oxidizing atmosphere through purging with air at 700 sccm for 15 minutes (step S130).

In step (4), after 15 minutes, heat treatment was performed for 2 hours while purging with air at 300 sccm. After completion of heat treatment, cooling was performed while purging with air at 100 sccm (S140).

The resulting product was analyzed through XRD. The results thereof are shown in FIG. 7.

FIG. 7 shows results of XRD of Example 1 prepared by the preparation process according to an embodiment of the present disclosure. With reference thereto, the rutile structure of RuO₂ and the fcc phase of Pt in the prepared catalyst were confirmed through XRD analysis. The hcp phase of Ru(0) was not observed, from which it can be interpreted that Ru was present in an oxide state and Pt was present in a metal state, indicating that the catalyst with Pt in RuO₂ was synthesized as intended.

### Test Example 3: Analysis Result Upon Non-Continuous Heat Treatment

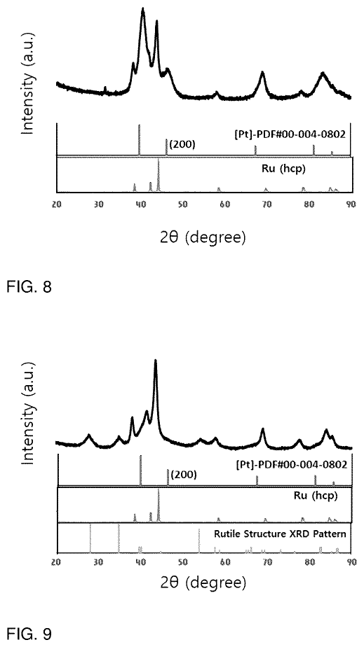

A test was conducted to confirm the necessity of continuous heat treatment, which is an essential condition differentiated from other heat treatment conditions, in the present disclosure. The results thereof are shown in FIGS. 8 and 9.

### Comparative Example 1

Step (1) (step S110) was performed in the same manner as in Example 1, followed by cooling at room temperature (15° C. to 25° C.) after reduction in a hydrogen atmosphere in step (2) (step S120).

### Comparative Example 2

Comparative Example 1 cooled after reduction was subsequently subjected to step (3) (step S130) and step (4) (step S140). Steps (3) and (4) were performed in the same manner as in Example 1.

FIG. 8 shows results of XRD of Comparative Example 1. FIG. 9 shows results of XRD of Comparative Example 2. With reference thereto, in the catalyst cooled after reduction in a hydrogen atmosphere as shown in FIG. 8, all active materials were reduced to a zero-valent state from the metal oxide. However, in the catalyst prepared by continuing subsequent steps, only a portion of the catalyst was oxidized and most metal was in a zero-valent state as shown in FIG. 9, indicating that only the desired metal was not oxidized.

It can be confirmed that selective oxidation at the oxidation temperature is possible only when the gas atmosphere is changed while maintaining the temperature without cooling in the reduction step.

### Test Example 4: Analysis Result at Temperature in Step (2) Falling Out of Range of the Present Disclosure

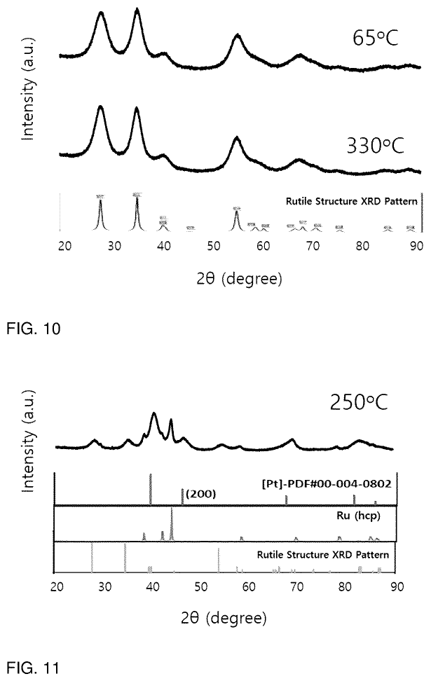

A test was conducted to confirm the effect of the range of temperature in step (2) of the present disclosure. The results thereof are shown in FIGS. 10 and 11.

### Comparative Example 3

This comparative example was performed in the same manner as in Example 1, with the exception that step (2) (step S120) was performed at 65° C.

### Comparative Example 4

This comparative example was performed in the same manner as in Example 1, with the exception that step (2) (step S120) was performed at 330° C.

FIG. 10 shows results of XRD of Comparative Example 3. FIG. 11 shows results of XRD of Comparative Example 4. With reference thereto, it can be seen that the catalyst was not reduced at a temperature falling out of the range of the present disclosure. In addition, even when the catalyst once reduced by the method of the present disclosure was oxidized at a temperature falling out of the range of the present disclosure, only a portion thereof was oxidized and selective oxidation of a specific active material did not occur.

### Test Example 5: Analysis Result for Heat Treatment Time Falling Out of Range of the Present Disclosure

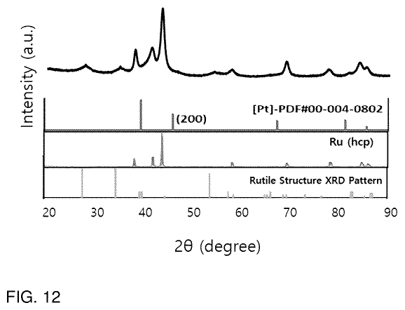

A test was conducted to confirm the effect of the range of heat treatment time of the present disclosure. The results thereof are shown in FIG. 12.

### Comparative Example 5

This comparative example was performed in the same manner as in Example 1, with the exception that step (2) (step S120) was performed for 5 hours and step (4) (step S140) was performed for 1 hour.

FIG. 12 shows results of XRD of Comparative Example 5. With reference thereto, it can be seen that, when the time fell out of the range of the present disclosure, all active materials were reduced, but selective oxidation did not occur.

Therefore, in the present disclosure, a catalyst for an electrochemical reaction that is prepared under specific conditions includes active materials having different oxidation states. Accordingly, a specific active material is oxidized to thus maintain good activity of a metal oxide while the other active material is in a zero-valent state. Thus, electrons are provided from the metal oxide to prevent dissolution due to peroxidation of the metal oxide, ultimately improving performance of the catalyst.

As is apparent from the above description, according to the present disclosure, when a catalyst for electrochemical reaction is prepared under specific conditions, active materials having different oxidation states are contained therein. A specific active material is oxidized to thus maintain good activity of a metal oxide while the other active material is in a zero-valent state. Thus, electrons are provided from the metal oxide, thereby preventing dissolution due to peroxidation of the metal oxide, ultimately improving performance of the catalyst.

The effects of the present disclosure are not limited to the above-mentioned effects. It should be understood that the effects of the present disclosure include all effects that can be inferred from the description of the present disclosure.

Although specific embodiments of the present disclosure have been described with reference to the accompanying drawings, those of ordinary skill in the art should appreciate that the present disclosure may be embodied in other specific forms without changing the technical spirit or essential features thereof. Thus, the embodiments described above should be understood to be non-limiting and illustrative in every way.

What is claimed is:

1. A method of preparing a catalyst for an electrochemical reaction, the method comprising:
(1) synthesizing a catalyst including a first active material and a second active material having a higher oxidation temperature than an oxidation temperature of the first active material;
(2) imparting fluidity to the catalyst by heat-treating the catalyst and reducing the first active material and the second active material;
(3) maintaining fluidity of the catalyst; and
(4) selectively oxidizing the first active material by performing heat treatment at a temperature lower than the oxidation temperature of the second active material.

2. The method of claim 1, wherein each of the first active material and the second active material in step (1) comprises: metalloids including boron (B), silicon (Si), germanium (Ge), arsenic (As), antimony (Sb), tellurium (Te), or polonium (Po); alkali metals including lithium (Li), sodium (Na), potassium (K), rubidium (Rb), cesium (Cs), or francium (Fr); alkaline earth metals including beryllium (Be), magnesium (Mg), calcium (Ca), strontium (Sr), barium (Ba), or radium (Ra); transition metals including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs), meitnerium (Mt), darmstadtium (Ds), roentgenium (Rg), or copernicium (Cn); or oxides thereof; or any combination thereof.

3. The method of claim 1, wherein, in step (1), the first active material is ruthenium oxide (RuO₂) and the second active material is platinum oxide (PtO₂).

4. The method of claim 1, wherein the catalyst of step (1) comprises the first active material and the second active material in a mass ratio in a range of 0.1 to 10:1.

5. The method of claim 1, wherein step (2) is performed within a range of 30 minutes to 3 hours at a temperature in a range of 350° C. to 550° C. in a hydrogen atmosphere.

6. The method of claim 1, wherein step (3) is performed at a temperature in a range of 200° C. to 500° C., and further comprises purging with an inert gas or purging with a gas that creates an oxidizing atmosphere.

7. The method of claim 6, wherein the inert gas comprises nitrogen (N₂), helium (He), neon (Ne), argon (Ar), krypton (Kr), xenon (Xe), radon (Rn), or any combination thereof.

8. The method of claim 6, wherein the gas that creates the oxidizing atmosphere is a gas mixture containing 5% or more of oxygen (O₂).

9. The method of claim 1, wherein step (4) is performed within a range of 1 hour to 3 hours at a temperature in a range of 300° C. to 500° C. in a gas atmosphere containing 5% or more of oxygen (O₂).

10. The method of claim 1, wherein peaks of the catalyst are observed at 2θ=28°±1°, 35°±1°, 40°±1°, 46°±1°, 54°±1°, 68°±1°, and 81°±1° in an X-Ray Diffraction (XRD) spectrum.

11. A method of preparing a catalyst for electrochemical reaction, the method comprising:
(1) synthesizing a catalyst including a first active material and a second active material having a higher reduction temperature than a reduction temperature of the first active material;
(2) imparting fluidity to the catalyst by heat-treating the catalyst and oxidizing the first active material and the second active material;
(3) maintaining fluidity of the catalyst; and
(4) selectively reducing the first active material by performing heat treatment at a temperature lower than the reduction temperature of the second active material.

12. The method of claim 11, wherein each of the first active material and the second active material in step (1) comprises: metalloids including boron (B), silicon (Si), germanium (Ge), arsenic (As), antimony (Sb), tellurium (Te), or polonium (Po); alkali metals including lithium (Li), sodium (Na), potassium (K), rubidium (Rb), cesium (Cs), or francium (Fr); alkaline earth metals including beryllium (Be), magnesium (Mg), calcium (Ca), strontium (Sr), barium (Ba), or radium (Ra); transition metals including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (db), seaborgium (Sg), bohrium (Bh), hassium (Hs), meitnerium (Mt), darmstadtium (Ds), roentgenium (Rg), or copernicium (Cn); or oxides thereof; or any combination thereof.

13. The method of claim 11, wherein, in step (1), the first active material is ruthenium (Ru) and the second active material is platinum (Pt), and wherein the catalyst comprises the first active material and the second active material in a mass ratio in a range of 0.1 to 10:1.

14. The method of claim 11, wherein step (2) is performed within a range of 1 hour to 3 hours at a temperature in a range of 300° C. to 500° C. in a gas atmosphere containing 5% or more of oxygen (O₂).

15. The method of claim 11, wherein step (3) is performed at a temperature in a range of 200° C. to 500° C., and comprises purging with an inert gas or purging with a gas that creates a reducing atmosphere.

16. The method of claim 11, wherein step (4) is performed within a range of 30 minutes to 3 hours at a temperature in a range of 350° C. to 550° C. in a hydrogen atmosphere.

17. The method of claim 11, wherein peaks of the catalyst are observed at 2θ=28°±1°, 35°±1°, 40°±1°, 46°±1°, 54°±1°, 68°±1°, and 81°±1° in an XRD spectrum.

18. A catalyst for an electrochemical reaction, the catalyst comprising:
a first active material; and
a second active material having an oxidation temperature, a reduction temperature, or both higher than that of the first active material,
wherein oxidation states of the first active material and the second active material are different from each other.

19. The catalyst of claim 18, wherein the first active material comprises ruthenium oxide (RuO₂) and the second active material comprises platinum (Pt).

20. The catalyst of claim 18, wherein peaks of the catalyst are observed at 2θ=28°±1°, 35°±1°, 40°±1°, 46°±1°, 54°±1°, 68°±1°, and 81°±1° in an XRD spectrum.
